(19) United States
(12) Patent Application Publication
(10) Pub. No.: US 2025/0222686 A1
(43) Pub. Date: Jul. 10, 2025

(54) VACUUM FILM PASTING BOX

(71) Applicant: ZHIGUANG WEN, SHENZHEN CITY (CN)

(72) Inventor: ZHIGUANG WEN, SHENZHEN CITY (CN)

(21) Appl. No.: 19/095,012

(22) Filed: Mar. 30, 2025

Related U.S. Application Data
(63) Continuation of application No. PCT/CN2023/124230, filed on Oct. 12, 2023.

(30) Foreign Application Priority Data
Oct. 13, 2022 (CN) 202222701444.0
Oct. 13, 2022 (CN) 202222705330.3
Jun. 6, 2023 (CN) 202321429850.4

(51) Int. Cl. B32B 37/00; B32B 38/18

(52) U.S. Cl. CPC B32B 37/0046; B32B 38/1858; B32B 2309/68; B32B 2457/20

(57) ABSTRACT

A vacuum film pasting box, relating to the technical field of film pastings, comprises: a base box, a cover plate, and an elastic soft film. An air extraction hole is provided on the base box, and a vent hole is provided on the cover plate. The cover plate is arranged over the upper side of the base box, the elastic soft film is arranged between the base box and the cover plate, and a first space is defined between the elastic soft film and the base box. The first space is configured to accommodate an electronic equipment and a protective film. The air extraction hole is in communication with the first space and an external environment of the base box, and is configured to connect an external negative pressure equipment.

### FIELD OF THE DISCLOSURE

The present disclosure relates to the technical field of film pasting, specifically to a vacuum film pasting box.

### BACKGROUND OF THE DISCLOSURE

With the rapid advancement of intelligent technology, electronic equipments such as mobile phones and tablets have become widely used in daily life. To protect the display screens of these electronic equipments, users typically apply a protective film to the screen. However, during the application process, users manually apply the protective film or use auxiliary film applicators. A common issue is that small amounts of air often remain between the protective film and the screen, leading to the formation of bubbles, which negatively impacts the quality of the film pasting process.

### SUMMARY OF THE DISCLOSURE

To address the deficiencies and drawbacks of the existing technology, the present disclosure provides a vacuum film pasting box that significantly reduces bubble formation during the film pasting process.

To achieve the above objective, the present disclosure provides a vacuum film pasting box, comprising: a base box, a cover plate, and an elastic soft film; wherein an air extraction hole is provided on the base box; a vent hole is provided on the cover plate; the cover plate is arranged over an upper side of the base box; the elastic soft film is arranged between the base box and the cover plate, the elastic soft film is abutted against an inner side of the cover plate, a first space is defined between the elastic soft film and the base box; the first space is configured to accommodate an electronic equipment and a protective film; the air extraction hole connects the first space to an external environment of the base box and is configured to be connected to an external negative pressure equipment, a first limiting device is provided inside the base box to position the electronic equipment, and a second limiting device is provided inside the base box to position the protective film.

By adopting the above technical solution, the present disclosure provides the following beneficial effects. In the present disclosure, an elastic soft film is arranged between the base box and the cover plate, a first space is defined between the base box and the elastic soft film, the cover plate abuttes against the elastic soft film, an air extraction hole is provided on the base box, and a vent hole is provided on the cover plate. During operation, the electronic equipment and the protective film are placed inside the first space, the vent hole is sealed, and the negative pressure equipment is activated. Since there is no space or only a minimal space between the cover plate and the elastic soft film, the elastic soft film does not press downward when the negative pressure equipment evacuates the air. Once the first space is devoid of air, the vent hole is unsealed, so as to allow external air to enter the upper side of the elastic soft film. At this moment, the negative pressure equipment continues vacuum extraction, and the elastic soft film presses downward to tightly adhere the protective film onto the screen of the electronic equipment, thereby completing the film pasting process. Since the first space is free of air, no bubbles are formed after the film pasting process.

To achieve the above objective, the present disclosure adopts another technical solution, which provides a vacuum film pasting box, comprising: a base box, a cover plate, and an elastic soft film; wherein an air extraction hole is provided on the base box; a vent hole is provided on the cover plate; the cover plate is arranged over an upper side of the base box; the elastic soft film is arranged between the base box and the cover plate and a first space is defined between the elastic soft film and the base box, a second space is defined between the elastic soft film and the cover plate; the first space is configured to accommodate an electronic equipment and a protective film, the air extraction hole connects the first space to an external environment of the base box and is configured to be connected to a negative pressure equipment, the vent hole connects the second space to an external environment of the cover plate and is configured to be connected to an external negative pressure equipment; a first limiting device is provided inside the base box to position the electronic equipment, and a second limiting device is provided inside the base box to position the protective film.

By adopting the above technical solution, the present disclosure provides the following beneficial effects. In the present disclosure, an elastic soft film is arranged between the base box and the cover plate, a first space is defined between the elastic soft film and the base box, a second space is defined between the elastic soft film and the cover plate, an air extraction hole is provided on the base box, and a vent hole is provided on the cover plate. During operation, the electronic equipment and the protective film are placed inside the first space, and the negative pressure equipment is activated. The first space and second space are evacuated simultaneously, ensuring that the air pressure in the first space and second space remains balanced. Once the first space is devoid of air, the first space continues vacuum extraction, while the second space stops vacuum extraction, so as to allow external air to enter, such that the elastic soft film presses downward to tightly adhere the protective film onto the screen of the electronic equipment, thereby completing the film pasting process. Since the first space is completely free of air, no bubbles are formed after the film pasting process.

### BRIEF DESCRIPTION OF THE DRAWINGS

To provide a clearer illustration of the embodiments of the present disclosure or the technical solutions in the prior art, the following is a brief introduction to the drawings required for describing the embodiments or prior art. It is evident that the drawings described below are merely some embodiments of the present disclosure. For an ordinary person skilled in the art, additional drawings can be obtained without creative efforts based on these drawings.

FIG. 1 is an exploded structural schematic diagram of Embodiment 1.

FIG. 2 is another exploded structural schematic diagram of Embodiment 1 from a different perspective.

FIG. 3 is a structural schematic diagram of Embodiment 1, in which a portion of the casing of the negative pressure equipment is opened.

FIG. 4 is an exploded structural schematic diagram of Embodiment 2.

FIG. 5 is another exploded structural schematic diagram of Embodiment 2 from a different perspective.

FIG. 6 is a structural schematic diagram of Embodiment 3.

FIG. 7 is a structural schematic diagram of Embodiment 3, in which the negative pressure equipment is separated from the base box and cover plate.

FIG. 8 is a structural schematic diagram of the base box in Embodiment 3.

FIG. 9 is a schematic diagram of the first limiting component, the second limiting component, the third limiting component, and the fourth limiting component being detached from the base box.

FIG. 10 is a structural schematic diagram of the first limiting component.

Reference numerals: 1: Base box; 11: Convex ring; 12: Limiting convex column; 13: Second reinforcement rib; 14: First limiting component; 141: Raised block; 142: Positioning convex column; 15: Second limiting component; 16: Third limiting component; 17: Fourth limiting component; 18: Insertion slot; 2: Cover plate; 21: Groove; 22: First reinforcement rib; 3: Elastic soft film; 4: Negative pressure equipment; 41: Casing; 42: Micro air pump; 43: Charging port; 5: Ultraviolet lamp; a: First space; b: Second space; c: Air extraction hole; d: Exhaust hole; e: Vent hole.

### DETAILED DESCRIPTION OF THE EXEMPLARY EMBODIMENTS

The specific embodiments described herein solely serve as explanations of the present disclosure and should not be construed as limitations. Those skilled in the art may make modifications to these embodiments without creative effort after reading this specification. However, any modifications that fall within the scope of the claims of this invention are protected under patent law.

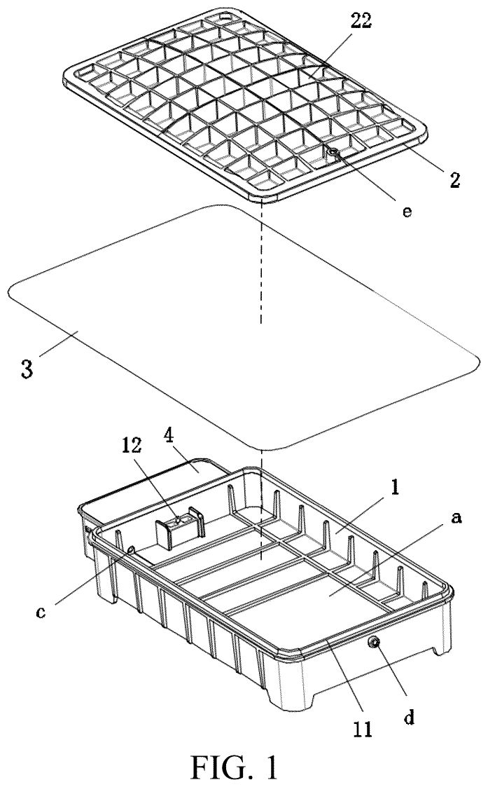

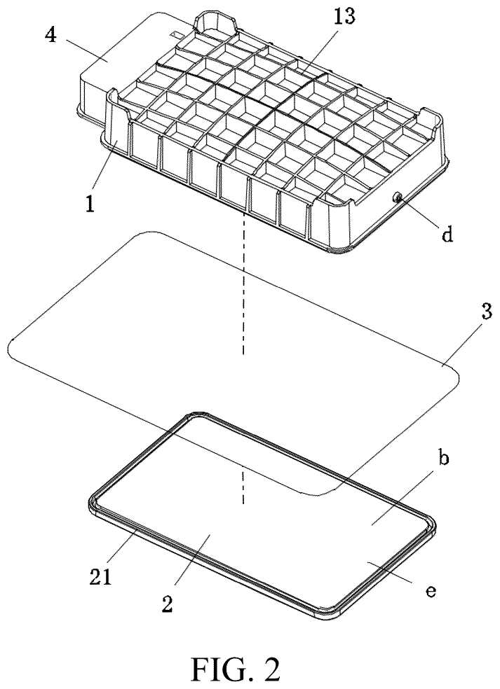

Embodiment 1: This embodiment relates to a vacuum film pasting box, as shown in FIG. 1 to FIG. 2, comprising: a base box 1, a cover plate 2, a negative pressure equipment 4, and an elastic soft film 3. An electronic equipment and a protective film are also required during the film pasting process.

An air extraction hole c is provided on the base box 1, and a vent hole e is provided on the cover plate 2. The cover plate 2 is arranged over the upper side of the base box 1. The elastic soft film 3 is located between the base box 1 and the cover plate 2. A first space a is defined between the elastic soft film 3 and the base box 1. The inner surface of the cover plate 2 is flat, and the elastic soft film 3 is abutted against the inner side of the cover plate 2. There is no space or only minimal space between the cover plate 2 and the elastic soft film 3. The first space a is configured to place an electronic equipment and a protective film. In this embodiment, the air extraction hole c connects the first space a to the negative pressure equipment 4. In other embodiments, the vacuum film pasting box may not include the negative pressure equipment 4 but instead rely on an external negative pressure equipment for vacuum extraction, i.e., the air extraction hole c is spatially communicated with the first space a and the external environment of the base box 1 and configured to connect an external negative pressure equipment. In this embodiment, the vent hole e is provided on the upper side of the cover plate 2.

During use, the electronic equipment and the protective film are placed inside the first space a, the vent hole e is sealed, and the negative pressure equipment 4 is activated. Since there is no space or only minimal space between the cover plate 2 and the elastic soft film 3, the elastic soft film 3 does not press downward when the negative pressure equipment 4 evacuates air. When the first space a without air, the vent hole e is unsealed, so as to allow external air to enter the upper side of the elastic soft film 3. At this moment, the negative pressure equipment 4 continues vacuum extraction, and the elastic soft film 3 will press downward to tightly adhere the protective film onto the screen of the electronic equipment, so as to complete the film pasting process. Since the first space a without air, the film pasting process does not produce bubbles.

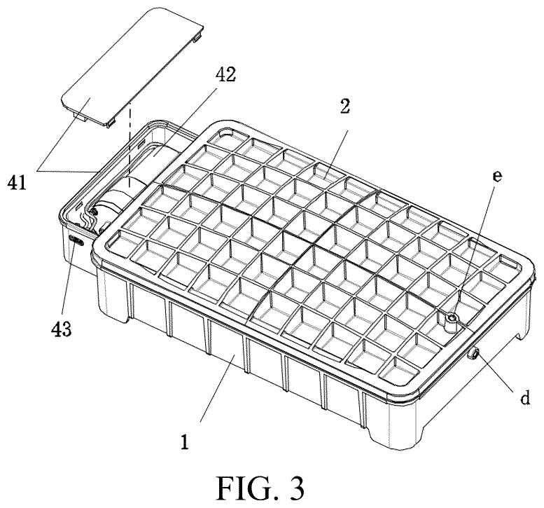

In this embodiment, as shown in FIG. 3, the negative pressure equipment 4 comprises: a casing 41, a micro air pump 42 provided inside the casing 41, and a charging port 43 provided on the casing 41 for charging the micro air pump.

As a preferred solution, as shown in FIG. 1 to FIG. 3, an exhaust hole d is provided on the base box 1 and connected to the first space a. During the film pasting process, the exhaust hole d needs to be sealed, and after the film pasting process, the exhaust hole d is opened to release pressure, making it easier to open the cover plate 2.

The base box 1 and the cover plate 2 are detachably connected. When the base box 1 and the cover plate 2 are connected to each other, the base box 1 and the cover plate 2 collectively clamp and secure the elastic soft film. Specifically, in this embodiment, as shown in FIG. 1 and FIG. 2, a convex ring 11 is provided on the upper side of the base box 1, and a groove 21 corresponding to the convex ring 11 is provided on the lower side of the cover plate 2. The convex ring 11 and the groove 21 fit together to improve the sealing between the base box 1 and the cover plate 2. In other embodiments, the base box 1 and the cover plate 2 may also be detachably connected by other means, such as snap-fit connections.

In this embodiment, the elastic soft film 3 is an elastic thin film. In other embodiments, the elastic soft film 3 may also be an elastic bag. The elastic bag can directly enclose the entire cover plate 2.

As a preferred solution, as shown in FIG. 1 and FIG. 2, the base box 1 is provided with a first limiting device for centering the electronic equipment and a second limiting device for centering the protective film. By providing the first limiting device and the second limiting device, both the accuracy film pasting process of electronic equipment and the ease of suspending the protective film are improved. Specifically, in this embodiment, the first limiting device comprises a plurality of guiding blocks (not shown) provided at the inner corners of the base box 1, with the electronic equipment placed between the plurality of guiding blocks to be centrally positioned inside the base box 1. The second limiting device comprises two limiting convex columns 12 respectively arranged on both sides inside the base box 1, with the protective film being suspended via two positioning holes onto the limiting convex columns 12, ensuring that the protective film is centrally positioned above the electronic equipment.

The protective film has at least three layers, which are: a release film, a protective film body, and a positioning film in sequence. During the film pasting process, the release film is first removed, and then the positioning film is fixed inside the base box 1, with the protective film body facing upward toward the electronic equipment. During the film pasting process, the positioning film automatically tears off, or the positioning film can be manually torn off after the film has been applied.

When the negative pressure equipment 4 is working, deformation of the cover plate 2 and the base box 1 may occur. To prevent the situation, as shown in the figure, the top of the cover plate 2 is convexly arched, and a plurality of first reinforcement ribs 22 are provided. The bottom of the base box 1 is also convexly arched, and a plurality of second reinforcement ribs 13 are provided. Specifically, in this embodiment, the top of the cover plate 2 is equipped with a plurality of first reinforcement ribs 22 that are vertically arranged and a plurality of first reinforcement ribs 22 that are horizontally arranged, and the plurality of first reinforcement ribs 22 that are vertically arranged and the plurality of first reinforcement ribs 22 that are horizontally arranged intersect, which further increases the stability of the cover plate 2. The bottom of the base box 1 is equipped a plurality of second reinforcement ribs 13 that are vertically arranged and a plurality of second reinforcement ribs 13 that are horizontally arranged, and the plurality of second reinforcement ribs 13 that are vertically arranged and the plurality of second reinforcement ribs 13 that are horizontally arranged intersect, which further increases the stability of the base box 1.

The vacuum film pasting box is also equipped with a sealing insert (not shown). One end of the sealing insert can be detachably connected to the exhaust hole d and configured to seal the exhaust hole d, and another other end of the sealing insert can be detachably inserted into the vent hole e and configured to seal the vent hole e. When both the exhaust hole d and the vent hole e need to be sealed, both ends of the sealing insert are inserted. When only one of the exhaust hole d and the vent hole e needs to be sealed, only the corresponding end of the sealing insert is inserted.

The vacuum film pasting box can also be used with UV curing equipment by simply making the cover plate 2 transparent. During use, the vacuum film pasting box is first used for the film pasting process, and then the UV curing equipment provided above the vacuum film pasting box is activated to cure the protective film inside the box.

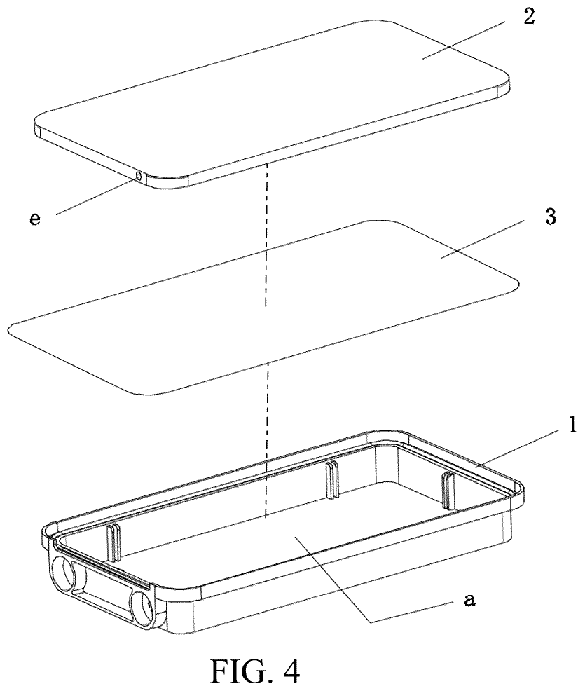

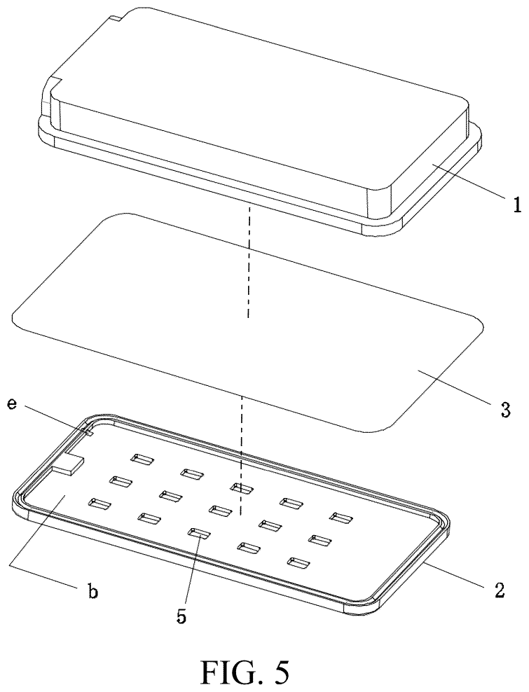

Embodiment 2: This embodiment relates to a vacuum film pasting box. Unlike Embodiment 1, as shown in FIG. 4 and FIG. 5, this embodiment does not include a negative pressure equipment 4 but instead relies on an external negative pressure equipment for vacuum extraction. Additionally, a second space b is defined between the elastic soft film 3 and the cover plate 2, and the vent hole e connects the second space b to the exterior of the cover plate 2 and is configured to connect an external negative pressure equipment.

The vent hole e is arranged on the side wall of the cover plate 2 and located on the same side as the air extraction hole c of the base box 1. Placing the vent hole e and the air extraction hole c on the same side facilitates the connection to an external negative pressure equipment.

The electronic equipment and the protective film are placed inside the first space a during use, and the external negative pressure equipment is activated. The first space a and the second space b are simultaneously evacuated to maintain the air pressure balance between the two spaces until the first space a is devoid of air. Then, the first space a continues evacuation, while the second space b stops evacuation and external air enters, causing the elastic soft film 3 to press downward, thereby tightly adhering the protective film onto the screen of the electronic equipment, so as to complete the film pasting process. Since the first space a is devoid of air, no bubbles are generated after the film pasting process.

In addition, as shown in FIG. 5, the inner side of the cover plate 2 is provided with a UV lamp 5. After the film pasting process, the UV lamp 5 is turned on to cure the protective film.

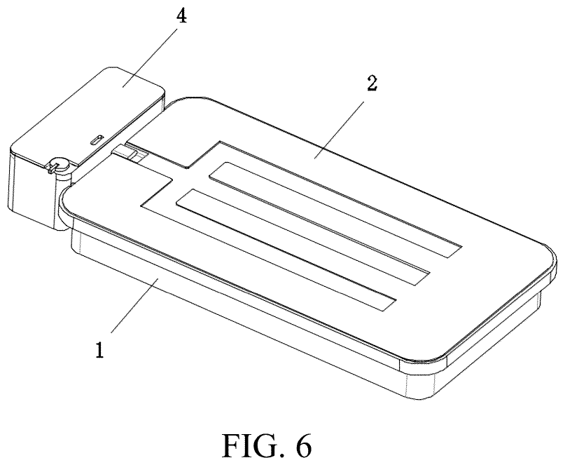

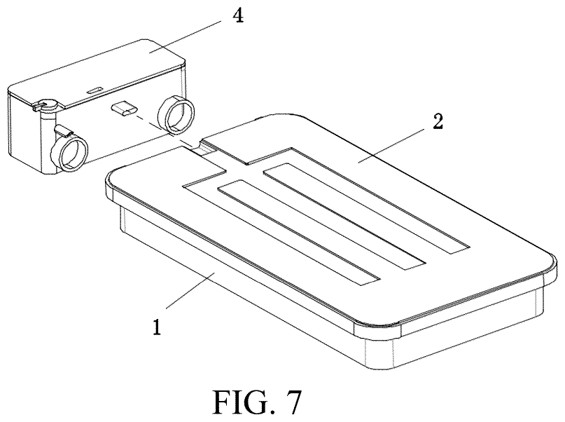

Embodiment 3: This embodiment relates to a vacuum film pasting box, differing from Embodiment 2 in that, as shown in FIG. 6 and FIG. 7, in this embodiment, the negative pressure equipment 4 is directly provided. As a preferred solution, the negative pressure equipment 4 is detachably connected to the base box 1 and the cover plate 2.

The vent hole e and the air extraction hole c are arranged on the same side. The negative pressure equipment 4 is connected to the vent hole e and the air extraction hole c. The ratio of the aperture sizes of the air extraction hole c and the vent hole e is the same as the volume ratio of the first space a and the second space b to ensure that during the initial stage of evacuation, the protective film does not press downward. In this embodiment, a power component is also provided inside the casing 41 of the negative pressure equipment 4, which can supply power to the UV lamp 5 and the negative pressure equipment 4.

In this embodiment, the base box 1 is also provided with a first limiting device for centering the electronic equipment and a second limiting device for centering the protective film.

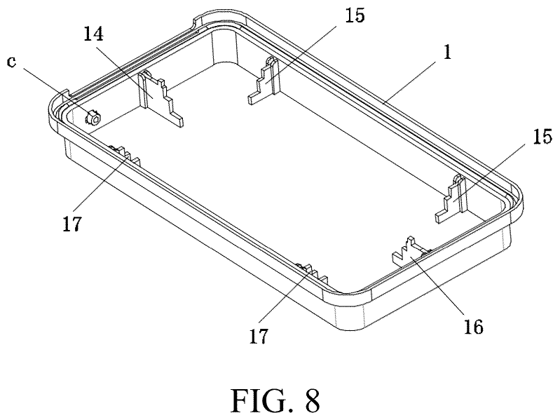

As shown in FIG. 8 to FIG. 10, the first limiting device includes: a first limiting component 14 detachably mounted on the inner sidewall of the base box 1, a second limiting component 15 detachably mounted on the inner sidewall of the base box 1 and arranged opposite to the first limiting component 14, a third limiting component 16 detachably mounted on the inner sidewall of the base box 1 and arranged perpendicular to the first limiting component 14, and a fourth limiting component 17 detachably mounted on the inner sidewall of the base box 1 and arranged opposite to the third limiting component 16. The first limiting component 14, the second limiting component 15, the third limiting component 16, and the fourth limiting component 17 collectively form a rectangular space for positioning and placing the electronic equipment.

By detachably mounting the first limiting component 14, the second limiting component 15, the third limiting component 16, and the fourth limiting component 17 on the four inner sidewalls of the base box 1, these four limiting components collectively form a rectangular space for positioning and placing the electronic equipment. By replacing the limiting components with different specifications, the device can accommodate electronic equipments of different sizes, making it widely applicable.

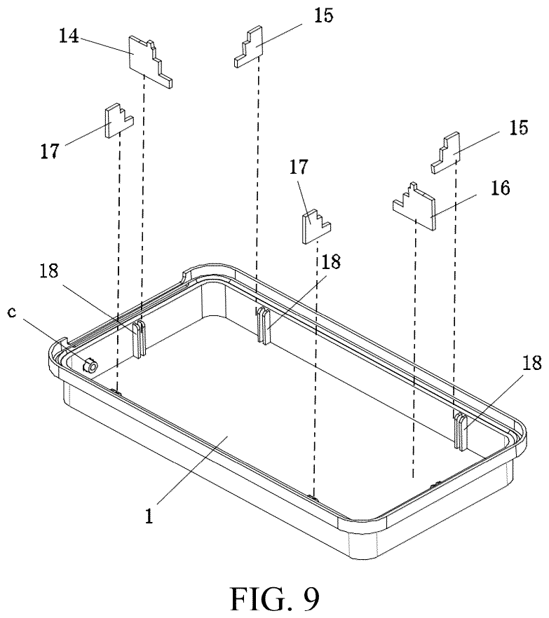

In this embodiment, as shown in FIG. 9, the inner sidewall of the base box 1 is provided with insertion slots 18 for the detachable insertion of the first limiting component 14, the second limiting component 15, the third limiting component 16, and the fourth limiting component 17. The first limiting component 14, the second limiting component 15, the third limiting component 16, and the fourth limiting component 17 are all in the form of flat sheets.

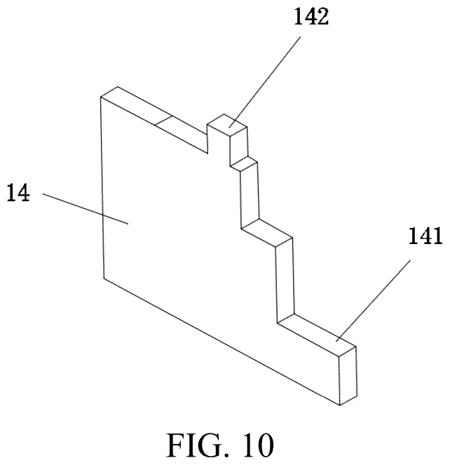

As a preferred solution, as shown in FIG. 10, the bottom of the first limiting component 14, the bottom of the second limiting component 15, the bottom of the third limiting component 16, and the bottom of the fourth limiting component 17 are provided with forward-extending raised blocks 141 for placing the bottom of the electronic equipment. The height of the raised block 141 is greater than the thickness of the protruding rear camera of the electronic equipment. The raised block 141 ensures that the rear camera of the electronic equipment does not come into contact with the bottom of the base box 1, so as to prevent scratches on the rear camera while also ensuring balance during the film pasting process.

As shown in FIG. 10, the second limiting device comprises two positioning convex columns 142 respectively arranged at the top of the first limiting component 14 and the third limiting component 16. The positioning convex columns 142 cooperate with the positioning holes on the protective film to complete the positioning of the protective film.

In this embodiment, the base box 1 is rectangular. In other embodiments, the base box 1 may also be oval. In this embodiment, there is one first limiting component 14 and one third limiting component 16, while there are two second limiting components 15 and two fourth limiting components 17. Since electronic equipment, such as mobile phones, are longer on the left and right sides, the second limiting component 15 and the fourth limiting component 17 are each provided in pairs to better facilitate positioning.

The above description is solely intended to explain the technical solution of the present disclosure and not to limit it. Any modifications or equivalent replacements made by ordinary skilled persons in the field without departing from the spirit and scope of the technical solution of the present disclosure should be included within the scope of the claims of the present disclosure.

What is claimed is:

1. A vacuum film pasting box, comprising: a base box (1), a cover plate (2), and an elastic soft film (3); wherein an air extraction hole (c) is provided on the base box (1); a vent hole (e) is provided on the cover plate (2); the cover plate (2) is arranged over an upper side of the base box (1); the elastic soft film (3) is arranged between the base box (1) and the cover plate (2), the elastic soft film (3) is abutted against an inner side of the cover plate (2), a first space (a) is defined between the elastic soft film (3) and the base box (1); the first space (a) is configured to accommodate an electronic equipment and a protective film; the air extraction hole (c) connects the first space (a) to an external environment of the base box (1) and is configured to be connected to an external negative pressure equipment; a first limiting device is provided inside the base box (1) to position the electronic equipment, and a second limiting device is provided inside the base box (1) to position the protective film.

2. The vacuum film pasting box according to claim 1, wherein an inner surface of the cover plate (2) is flat.

3. The vacuum film pasting box according to claim 1, wherein an exhaust hole (d) is provided on the base box (1).

4. The vacuum film pasting box according to claim 1, wherein the base box (1) and the cover plate (2) are detachably connected to each other, and, wherein, when the base box (1) and the cover plate (2) are connected to each other, the base box (1) and the cover plate (2) collectively clamp and secure the elastic soft film (3).

5. The vacuum film pasting box according to claim 1, wherein the first limiting device is configured to centrally position the electronic equipment.

6. The vacuum film pasting box according to claim 1, wherein the second limiting device is configured to centrally position the protective film.

7. The vacuum film pasting box according to claim 1, further comprising: a negative pressure equipment (4) mounted on the base box (1) and spatially communicated with the air extraction hole (c).

8. The vacuum film pasting box according to claim 1, wherein a top of the cover plate (2) is convexly arched and provided with a plurality of first reinforcement ribs (22), and a bottom of the base box (1) is convexly arched and provided with a plurality of second reinforcement ribs (13).

9. The vacuum film pasting box according to claim 3, wherein the vacuum film pasting box comprises a sealing insert, wherein one end of the sealing insert is detachably inserted into the exhaust hole (d) and configured to seal the exhaust hole (d), and another end of the sealing insert is detachably inserted into the vent hole (e) and configured to seal the vent hole (e).

10. A vacuum film pasting box, comprising: a base box (1), a cover plate (2), and an elastic soft film (3); wherein an air extraction hole (c) is provided on the base box (1); a vent hole (e) is provided on the cover plate (2); the cover plate (2) is arranged over an upper side of the base box (1); the elastic soft film (3) is arranged between the base box (1) and the cover plate (2) and a first space (a) is defined between the elastic soft film (3) and the base box (1), a second space (b) is defined between the elastic soft film (3) and the cover plate (2); the first space (a) is configured to accommodate an electronic equipment and a protective film; the air extraction hole (c) connects the first space (a) to an external environment of the base box (1) and is configured to be connected to a negative pressure equipment (4), the vent hole (e) connects the second space (b) to an external environment of the cover plate (2) and is configured to be connected to an external negative pressure equipment; a first limiting device is provided inside the base box (1) to position the electronic equipment, and a second limiting device is provided inside the base box (1) to position the protective film.
